(19) United States
(12) Patent Application Publication
(10) Pub. No.: US 2004/0022234 A1
(43) Pub. Date: Feb. 5, 2004

(54) Regional communication network

(76) Inventor: Shu Hagiwara, Tokyo (JP)

Correspondence Address: Fleshner & Kim, PO Box 221200, Chantilly, VA, 20153-1200, US

(21) Appl. No.: 10/416,000

(22) PCT Filed: Apr. 24, 2001
(86) PCT No.: PCT/JP01/03527

(30) Foreign Application Priority Data
Nov. 9, 2000 (JP) 2000-341334

(51) Int. Cl. H04L 12/66

(52) U.S. Cl. 370/352; 370/392

(57) ABSTRACT

A loop of transmission path (14) is formed by connecting, in a chain, communication stations (13) to which users (11, 12) having one or more terminals are connected. More direct communication is established when subscribers near to each other intercommunicate, for example, when a communication station and the party communication station belonging to the same transmission loop intercommunicate. Therefore no extra communication traffic is generated.

### FIELD OF THE INVENTION

The present invention relates to a regional communication network usable for the Internet or the like, and in particular relates to a regional communication network using radio communication.

### BACKGROUND ARTS

In the conventional Internet, as shown in FIG. 6, a method that each user connects each other by using a telephone circuit through a contracted Internet service provider (ISP) is popularly used. Each ISP is connected to an upper ISP, and the upper ISP is connected to a backbone communication path possessed by a telephone company or the like through the Internet exchange (IX).

Communication between terminals is done through the upper ISP and the IX when the other side of terminals is not connected to the same ISP.

For providers located in Osaka, Fukuoka and elsewhere, in many cases their upper ISP or IX is located in Tokyo. In such a case, when a user in Osaka places a telephone call to another user in Fukuoka over the Web, the communication path is open to traffic by connecting an ISP in Osaka to an ISP in Fukuoka through an IX in Tokyo. In this case, compared with direct connection between Osaka and Fukuoka, extra traffic for shuttling between Osaka and Tokyo is necessary, and by that much, the communication path becomes complicated, and that often causes communication failures, such as a delay, a packet loss or congestion.

Incidentally, since the communication path is hierarchical in the conventional arts, there has been a problem that domination of upper ISP, IX, telephone companies and the like is prominent, the decisions about network charges or service quality are held by these so as to easily occur conditions impeding the free development of Internet services.

Moreover, the communication path has a weakness, because the communication path is hierarchical, when a trouble occurs in the upper ISP or the IX, it is very difficult, and sometimes not possible, for a terminal to communicate outside the communication station to which the terminal is connected.

Incidentally, traffic volume of the Internet is larger in local traffic for short-range communication than in global traffic for long-range communication, as a tendency. Also, it is expected that the use of Internet telephones will rapidly increase in the future.

So far as the conventional electronic mailing or Web-browsing is concerned, even if some breaks occurred in transmission of information, they can be covered up by gathering to display all of the finally necessary contents using techniques, such as a retransmission control. However, in the case of Internet telephone, audio signals should be kept to be continuous and free of breaks so as to secure audio quality and realize smooth conversation.

Therefore, the Internet communication which treats data signals mixed with audio signals, needs to transmit data signal packets at adequate intervals by means of complicated delivery controls about packets carrying the data signals and packets carrying the audio signals, not to get the users to have an unnatural impression.

### DISCLOSURE OF THE INVENTION

An object of the present invention, therefore, is to provide a strong communication network, which does not generate extra traffic when parties who locate near in distance communicate with each other and weakens the domination of upper service companies by freeing from the hierarchical structure of the communication path. Moreover, another object of the present invention is to provide a communication network which can transmit quality audio signals by simple control particularly when the network is used for Internet telephone.

To solve the objects mentioned above, the regional communication network according to the present invention is characterized in that a loop of transmission path is formed by connecting in a chain communication stations to which users having one or more terminals are connected.

In addition, it is preferable that the loop of transmission path includes at least one key communication station for exchanging electronic information with an external key communication station.

Moreover, the loop of transmission path may be formed by connecting in a chain more than two of key communication stations.

Since in the above-mentioned regional communication network, stations to connect to personal users or LANs are directly connected to each other by means of communication paths, more direct communication is established and no extra communication traffic occurs without intervention of an upper communication station or a telephone company when subscribers living near to each other intercommunicate in such a case in which a communication station of the sender and a communication station of the receiver belong to the same transmission loop.

Moreover, since the communication path is not of a hierarchical structure interposing an upper device, it is possible to make communication free from domination of the upper organization.

Further, by providing a key communication station in the loop of transmission path to exchange electronic information with an external key communication station, it is possible, even when a communication party is located outside the loop of transmission path, to sequentially approach a goal by coursing through loops of transmission path one after another through key stations, eventually to reach the loop of transmission path to which the communication party belongs, and to make intended communication.

In this case, also, excluding domination of the upper organization, freer communication is possible, and, since loops of transmission path are connected in network form, even if a trouble occurs, a reliable communication is made possible by easily getting around the troubled point.

Incidentally, when key communication stations themselves are connected in a chain and form a loop of transmission path by the same manner, it is possible to obtain the same effect to their upper communication stations and the like.

Furthermore, it is preferable that a regional communication network of the present invention is arranged so that the loop of transmission path is formed by connecting in a chain two-way communication paths connecting one pair of the communication stations. The two-way communication path is provided with two communication paths. And the loop of the two-way communication path has a first closed loop and a second closed loop. The first closed loop and the second closed loop are reversed in the transmission direction, the first closed loop passes though an audio signal and the second closed loop passes through a data signal on normal. When one communication station gets into trouble, one closed loop is formed by connecting the two loops at the adjacent communication stations getting rid of the trouble communication station, and the audio signal and the data signal together pass through the newly formed one closed loop.

The regional communication network according to the present invention has two closed loops and redundancy, so that, even if a trouble occurs in the loop of transmission path, it is possible to secure a transmission path by avoiding the trouble point, and is highly reliable as a communication path.

Up to now in a LAN and the like, there have been methods, such as the FDDI system using a double optical fiber ring, for providing a sub-ring as a dummy for a main ring. Therefore when a trouble occurred, the trouble point can be avoided by looping back to the sub-ring base on the method.

In the present invention, using two loops of transmission paths, normally separate an audio signal and a data signal and the signals are sent to different communication loops respectively.

For the audio signal, of which transmission interval is limited for hearing naturally the transmitted sound, a packet transmission at constant bit rate (CBR) is preferable. Whereas, for the data signal, it is required to quickly transmit the number of packets corresponding to the amount of information to be transmitted, as possible, but the limitation of its interval is not so strict. Therefore, when the audio signal and the data signal pass through together with the one closed loop, it is necessary to control the communication path by properly inserting a packet of audio signal in the packet train of data signal so that the audio can be correctly restored.

The present invention, which focuses on the difference in nature between the audio signal and the data signal, does not only use the second closed loop at time of failure, but also secures continuity of audio communication and simplifies control of the communication path, by identifying two signals and running audio signals through the second communication path loop.

Incidentally, if a trouble occurs in the communication path loop connecting communication stations to each other, it is possible to secure reliability of communication by communicating through the mixing of audio signal and data signal, and transforming to a single signal path loop by looping back like the case in the FDDI system or the like.

Also, the two-way communication mentioned above is preferably done by radio.

By using radio communication, it is possible to easily form a loop of transmission path without laying electric cables or optical cables between communication stations. Incidentally, when forming the loop of transmission path, it is preferable to prevent interference of radio wave in a narrow zone by using an antenna with high directivity.

Moreover, a circular packet loaded with electronic information, which is cycled in the loop of transmission path of the present invention, may be applied as a memory device.

In a conventional communication network, when the amount of communication decreases and an empty space is generated in the network, empty packets synchronized with the clock of the network are run so as for electric signals to continuously flow by avoiding an underflow phenomenon and, to secure synchronization.

The present invention introduces the circular packet with a special header information to discriminate other packets, instead of the empty packet of the conventional network, and effectively uses the empty space in the network. The circular packet is intended to load information such as DNS code, Web cache, and dictionary, and cycle through the network when the space is free in any frequency range, and the circular packet is discarded when the circuit line becomes crowded.

Thus, by loading the adequate information such as DNS code, Web cache, and dictionary, on the packet and by letting it cycle through the network, it is possible to use the loop of transmission path itself as a virtual memory device commonly used by communication stations.

Furthermore, since the capacity of the transmission loop is large enough, in many cases, there is a surplus with regard to the amount of information to be transmitted. By loading and cycling the specified electronic information such as DNS code, it is also possible to use the transmission loop as the common memory device.

The circular packet can also be considered as a device for realizing a cache system on the network, which is held in the devices at a terminal, ISP or the like. Also, when information of dictionary is cycled, the effect is the same as caching on the network with the contents held by a single dictionary server and the like.

### BRIEF DESCRIPTION OF THE DRAWINGS

FIG. 1 is a block diagram showing the concept of a regional communication network of an embodiment.

FIG. 2 is a map showing an example of connections of the regional communication network.

FIG. 3 is a drawing explaining a loop of transmission path of the regional communication network.

FIG. 4 is a drawing showing a method for avoiding a trouble in the loop of transmission path.

FIG. 5 is a drawing explaining a case using the loop of transmission path of the embodiment as virtual memory device.

FIG. 6 is a block diagram showing a conventional Internet network.

### BEST METHOD FOR CARRYING OUT THE INVENTION

The present invention is to compose an Internet communication network by forming a regional communication network in each area and by connecting the formed regional communication networks.

Henceforth the present invention is described in detail based on the embodiment with reference to the drawings.

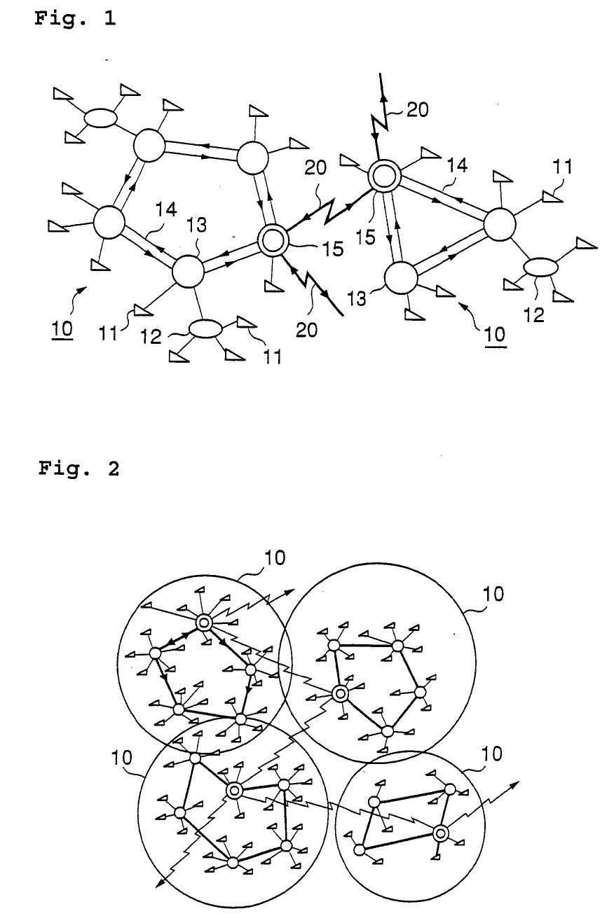

As shown in FIG. 1, a regional communication network 10 of the embodiment is formed by arranging a loop by connecting communication stations 13 by means of inter-station two-way communication paths 14. Each of the communication stations connects a number of user terminals 11 and local area networks (LAN) 12.

Each communication station 13 which belongs to the regional communication network 10 is not limited to a terminal and LAN which can be connected from a distance through public a telephone circuit, but as shown in FIG. 2, it can also be a terminal 11 and LAN 12 which are located in a relatively narrow area around a communication station 13 and connected by a special cable or a radio communication path. Additionally, of course, positional distribution of terminals connected to each communication station 13 can be intricate or overlapped.

When using radio for the communication path, as shown in FIG. 3, each communication station 13 which belongs to a regional communication network 10 provides a high-directive antenna 17 and forms an inter-station two-way radio communication path 14, by directing the antenna to a neighboring communication station 13 to be a target of communication.

The communication stations 13 by one pair connected in this manner are each connected to other communication stations 13 by the inter-station two-way radio communication path 14 in the same way, and an adequate number of communication stations 13 are connected by the inter-station two-way radio communication to form a closed loop.

The inter-station two-way radio communication path 14 of the regional communication network 10 forms two single-direction loops A, B of transmission path, each of which carries signals cycling round the network in reverse directions.

In the method of mixing and transmitting audio signals and data signals using one transmission path, when the circuit becomes crowded, a delay occurs in packet transfer, the effective transmission speed is lowered and the quality is degraded, causing breaks and huskiness in audio. Conventionally, to avoid the degradation of quality like this, a method to preferentially send an audio packet through a previously secured band, or to perform a stable communication by fixing a route, has been used.

In the case of the regional communication network 10 of the embodiment, under an anomaly-free condition of the communication path, transmission signals are separated into data signals and audio signals, and packets carrying only audio signals are passed through one loop of transmission path (A, for example) and packets carrying data signals are passed through the other loop of transmission path (B, for example).

As the mentioned above, since audio and data signals are handled separately, communication control of each is quite easy, and yet since independent closed loops are used, delay and breaks hardly occur.

Accordingly, it is possible to transmit signals requiring the real-time performance, particularly the audio signals, maintaining the quality.

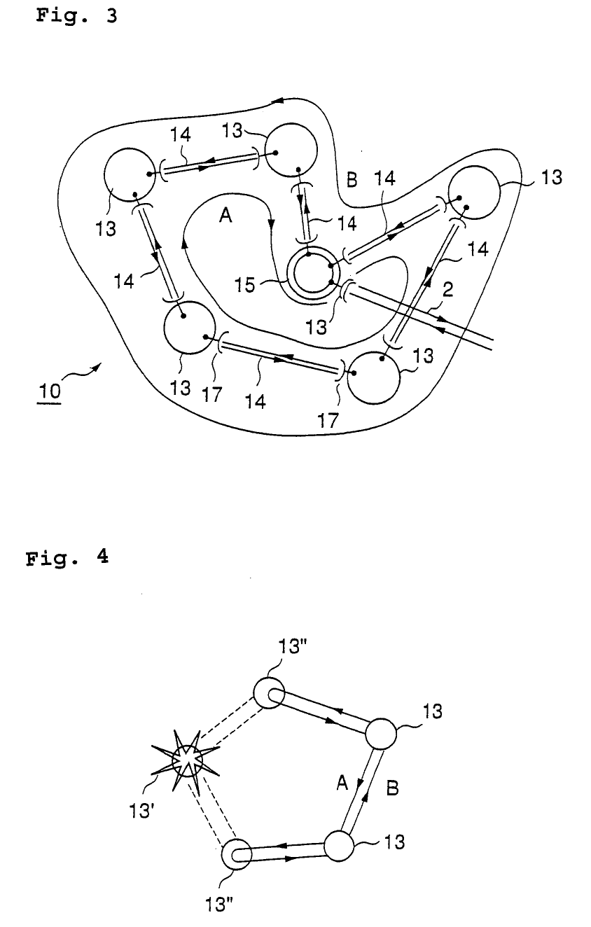

Incidentally, if a trouble occurs in the loop of transmission path, as shown in FIG. 4, two loops of transmission path A, B are connected and looped back by a communication station 13″ next to a communication station 13′ having the trouble, and transformed to one transmission path AB avoiding the troubled point. When changing to one closed loop AB, sophisticated controls by the prior art should be applied so as to transmit audio and data signals in mixed condition.

Also, one regional communication network 10 may contain one or more key stations 15. The key station 15 provides a relatively powerful directive antenna 18, and forms an Internet two-way radio communication path 20 with a key station 15 of a neighboring regional communication network 10.

The Internet two-way radio communication path 20 is further connected to a key communication station 15 of another regional communication network 10. If the Internet two-way radio communication path 20 preferably form a closed loop connecting an adequate number of regional communication networks 10, even when a trouble occurs in a part, it is possible to secure a communication path by generating an avoidance route and thus reliability for communication increases, but the Internet two-way radio communication path 20 may have an open circuit portion, where the regional communication network 10 forms a terminal end.

According to the regional communication network of the embodiment, when neighboring terminals are to communicate with each other, and when the communication stations to which the terminals belong are attached to the same regional communication network, the two communication are directly connected through a loop of transmission path, it is not necessary to bring signals to an upper IX and avoid traffic congestion.

Also, since audio signals and data signals are handled in separate closed loops, for the audio signal emphasizing the real-time performance, too, quality signal transmission can be done using an independent communication path and using a simple communication control method matching the characteristics.

Moreover, when terminals that belong to different regional communication networks are to communicate with each other, the communication is performed by connecting to a neighboring network through a key station of the regional communication network, and searching the target terminal using an address table and the like.

If the target terminal does not exist in the network, further the communication is performed by connecting to another regional communication network through the key station, and searching the target terminal. The same operations are repeated until the target terminal is found.

In the embodiment, key stations too are connected to each other by radio communication. Additionally, when the loop of transmission path described above is formed between key communication stations, it is possible to directly perform communication without an upper IX and the like located above the key stations.

Also, when a wider communication network is formed by connecting via loops of transmission path with the regional communication networks formed by connecting by loops of transmission path, a more reliable network can be obtained.

Incidentally, to secure smooth communication with the target terminal, key stations can provide routing tables and select a route to an intended network using the tables. A routing table is intended to previously register optimal routes, which are determined based on cost values related to service type, including distance to a target address, namely the hop number, delay of data, throughput, reliability and the like. Since the optimal route always changes by the condition of the network, the routing table is designed to be updated as needed according to new information.

In the regional communication network of the embodiment, two independent loops of transmission exist. The loops of transmission path form a closed loop by connecting communication stations in the network. Each communication station takes and analyzes signals which are passed through the transmission path, and if the addressee terminal is not connected, the station transmits the signal information to the next communication station. When the addressee terminal is connected, the communication station takes and distributes the information to the addressee terminal, and further, issues a response message telling the taking to the loop of transmission path. The response message goes through the closed loop and returns to the communication station to which the source terminal belongs, and then it is deleted.

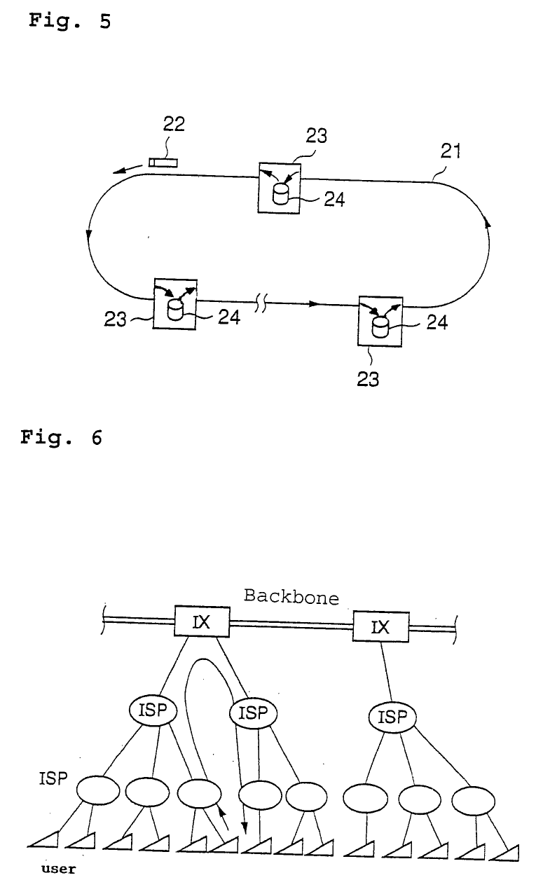

To perform procedure like this, the communication station is provided with a memory device for temporarily storing information transmitted from the transmission path and sending out the same information to the transmission path as needed. That is, as schematically shown in FIG. 5, an information 22 which cycles through a transmission loop 21 is held at a memory device 24 each time when the information passes through a communication station 23, and thereafter the information 22 is taken to the communication station or released to the transmission path, as needed. In a communication method using a packet, the packet for carrying information has a prescribed size, but often the amount of communicated information is not consistent with the packet size.

In communication as mentioned above, when the amount of information that a transmission path can carry is larger than the amount of information to be sent, it is possible to load the adequate information such as DNS code, Web cache or dictionary, in addition to transmitted information. Also, in packet communication, adequate information is loaded on a surplus part in the packet and cycled through the transmission path. Additionally, a method to previously load adequate information on the packet and overwrite the previously loaded information with information to be sent may be also acceptable.

A method is also available which is to cycle a dummy circular packet loaded with adequate information during a period when no information is transmitted. The circular packet is given specific ahead information for easy identification. Further, a method to load information such as a DNS code, a dictionary information and the like, of which fluctuations in amount do not comprise any obstacle, in extra spaces of frequency range used for communication is also available.

These methods are intended to use the loop of transmission path itself as a virtual memory device.

The information added to the extra space of the transmission path in this way can be taken out from the virtual memory device and used, as needed in the communication station. Additionally, dictionary information and the like can be commonly used by each communication station.

Incidentally, when using the loop of transmission path as a memory device as the above, the memory capacity becomes considerably large.

For example, supposing that a 155 Mbps loop of transmission path makes a round trip by 100 ms and the load factor is 30%, the memory capacity is calculated as: 155 Mbps×0.1 s×0.7/8 bit/byte=1.36 Mbyte, namely it is possible to loop more than 1 million characters.

### INDUSTRIAL APPLICABILITY

As described above, according to the regional communication network of the present invention, communication stations to which users are connected are mutually connected in a chain. When communicating with a neighboring terminal, communication can be done by directly connecting to the other party, avoiding any upper communication station or a backbone. Therefore, no extra communication traffic is generated, and it is possible to effectively establish a network excluding domination by upper organizations.

Moreover, by sending audio and data signals to the communication loop independently from each other using double closed loops, it is possible to perform a stable communication by omitting the complicated communication path control on normal.

What is claimed is:

1. A regional communication network, wherein each loop of transmission path is formed by connecting in a chain communication stations to which one or more terminals of users are connected.

2. The regional communication network according to claim 1, wherein said loop of transmission path includes at least one key communication station for exchanging electronic information with an external key communication station.

3. A regional communication network, wherein each loop of transmission path is formed by connecting in a chain more than one of key communication stations.

4. The regional communication network according to any one of claims 1 to 3, wherein said loop of transmission path is formed by connecting in a chain each pair of the communication stations which are connected to each other through a two-way communication provided with two communication paths, the two-way communication forms a first closed loop and a second closed loop reversed the transmission direction of the first closed loop, the first closed loop is used for audio signals and the second closed loop is used for data signals on normal, when one communication station gets into trouble, one connected closed loop is formed by connecting the first closed loop and the second closed loop at both of the communication stations adjacent to the troubled communication station, and the audio signal and the data signal together pass through said one connected closed loop.

5. The regional communication network according to any one of claims 1 to 4, wherein the two-way communication is performed by radio communication.

6. A regional communication network according to any one of claims 1 to 5, wherein said loop of transmission path is applied as a memory device by making electronic information circulation.

7. The regional communication network according to claim 6, wherein said electronic information is circulated loading on circular packets provided with specific header information for identification.

8. A communication network, wherein each loop of transmission path is formed by connecting in a chain more than one of the regional communication networks according to any one of claims 1 to 7.
